(19) United States
(12) Patent Application Publication
(10) Pub. No.: US 2014/0186574 A1
(43) Pub. Date: Jul. 3, 2014

(54) METHOD FOR PRODUCING AND CONNECTING FIBRE-REINFORCED COMPONENTS AND AIRCRAFT OR SPACECRAFT

(71) Applicant: Robert Alexander Goehlich, Hamburg (DE)

(72) Inventor: Robert Alexander Goehlich, Hamburg (DE)

(21) Appl. No.: 14/009,759

(22) PCT Filed: Apr. 3, 2012
(86) PCT No.: PCT/EP12/56083

§ 371 Date: Dec. 18, 2013

Related U.S. Application Data
(60) Provisional application No. 61/471,780, filed on Apr. 5, 2011.

(30) Foreign Application Priority Data
Apr. 5, 2011 (DE) 10 2011 006 792.2

(51) Int. Cl. B29D 99/00; B64C 1/06

(52) U.S. Cl. CPC B29D 99/001; B64C 1/069
USPC 428/104; 156/93

(57) ABSTRACT

A method for producing and connecting fibre-reinforced components, in particular for an aircraft or spacecraft. The method includes the steps of: (a) providing a textile planar structure, of which merely a first sub-region is impregnated with a matrix; (b) heating the textile planar structure which is impregnated in part, in such a way that the matrix provided in the first sub-region of the textile planar structure cures; (c) connecting the textile planar structure in a second sub-region of the textile planar structure, different from the first sub-region, by stitching the second sub-regions; (d) introducing a further matrix at least into the stitched second sub-regions of the textile planar structure; and (e) heating the impregnated textile planar structure in such a way that the further matrix present in the stitched second sub-regions of the textile planar structure cures. The present invention further relates to aircraft or spacecraft production.

### CROSS-REFERENCES TO RELATED APPLICATIONS

This application claims the benefit of the U.S. Provisional Application No. 61/471,780, filed on Apr. 5, 2011, and of the German patent application No. 10 2011 006 792.2 filed on Apr. 5, 2011, the entire disclosures of which are incorporated herein by way of reference.

### FIELD OF THE INVENTION

The present invention relates to a method for producing and connecting fibre-reinforced components, in particular for an aircraft or spacecraft. The present invention further relates to an aircraft or spacecraft.

### BACKGROUND OF THE INVENTION

In modern aviation, light materials such as fibre composite materials are increasingly being used so as to reduce the overall weight. Carbon-fibre-reinforced plastics material or CFRP denotes a fibre/plastics material composite, in which carbon fibres are generally embedded in what is known as a polymer matrix in a plurality of layers as reinforcement. The polymer matrix forms a substrate material which is adapted to absorb shearing forces. Since carbon fibres can absorb very high tensile stresses with little resilience, this material has a very high strength at a very low weight. The interactions of the two components, i.e. the carbon fibres and the polymer matrix, give the resulting material better properties than either of the individual components.

As stated previously, these fibre composite materials are used for producing components of an aircraft, such as the fuselage, the horizontal tail plane, the aerofoils and the like. In this context, what is known as a half-shell construction is often used, referring to the construction of an aircraft component generally in two shells. The two shells are interconnected by an adapted connecting method, in such a way that for an aircraft fuselage, an approximately round or oval cross-section of a fuselage portion is provided. The various fuselage portions, for example the tail region, the fuselage centre or the cockpit portion, produce the overall aircraft fuselage when arranged in succession. In aircraft construction, the half-shells are generally joined together by riveting, but in modern aircraft developments, gluing or laser welding is increasingly being used. The present invention is disclosed below in respect of the production of an aircraft fuselage in a half-shell construction using a fibre composite material, but without the invention being limited thereto.

DE 10 2006 023 865 A1 discloses a method for producing a fibre-reinforced component, in which two fibre materials are interconnected by adding a curable matrix material and by subsequent curing. In this method, the various fibre layers are interconnected over a large area.

In modern passenger aircraft construction, jumbo jets, such as the upcoming Airbus A350 or the Airbus A340 and Airbus A380 which are already mass-produced, are increasingly in demand to enhance efficiency. In these types of aircraft, the fuselage half-shells are riveted together at a lap joint because of the large dimensions of these parts. In this connection method, the various portions or fuselage half-shells are put in place and a sealant is applied. The components are subsequently aligned with one another and fixed using temporary fastening members. Subsequently, holes and depressions are made in the lap region using drilling jigs. Finally, the two components are riveted together in the lap region. This method thus disadvantageously involves a relatively complex and thus expensive and time-consuming assembly process.

### SUMMARY OF THE INVENTION

Against this background, one idea of the present invention is to provide a simplified method for producing and connecting fibre-reinforced components, in particular for an aircraft or spacecraft.

Accordingly, the following is provided:

A method for producing and connecting fibre-reinforced components, in particular for an aircraft or spacecraft, comprising the steps of: (a) providing a textile planar structure, of which merely a first sub-region is impregnated with a matrix; (b) heating the textile planar structure which is impregnated in part, in such a way that the matrix provided in the first sub-region of the textile planar structure cures; (c) connecting the textile planar structure in a second sub-region of the textile planar structure, different from the first sub-region, by stitching the second sub-regions; (d) introducing a further matrix at least into the stitched second sub-regions of the textile planar structure; and (e) heating the impregnated textile planar structure in such a way that the further matrix present in the stitched second sub-regions of the textile planar structure cures.

An aircraft or spacecraft comprising a plurality of fibre-reinforced components, at least two of the components being interconnected by a method according to the invention.

The idea behind the present invention is that in modern aircraft, and in particular in passenger jumbo jets, the various aircraft components are very large and therefore unwieldy for the connection process. The idea of the present invention is therefore to subdivide the production and connection process of a component into two steps. In a first step, a first region of a textile planar structure for a component is impregnated with a matrix and cured. The resulting component has sufficient strength and dimensional stability for said component to be handled for a connection process in a second step. The connection process in the second step takes place in the regions of the component which were not impregnated, and therefore not cured, in the first step. In these regions, components can be connected in a simple manner using a stitching process. Components interconnected in this manner have improved static and dynamic properties. Moreover, this type of assembly and connection process is also simplified, since drilling, which undesirably produces chips, and riveting are no longer required.

The fact that connecting rivets, which are used in very large numbers in jumbo jets in particular, are no longer required also makes it possible to achieve a significant weight reduction.

Moreover, the connection according to the invention exploits the advantages of a fibre composite material without having to forgo the benefits of the shell construction. In particular, this also makes it possible to achieve very high tolerances when connecting the components, since the components are merely preformed in the first production step. In a second production step, the connection regions at which the components are interconnected can thus be aligned with one another with very high precision and dimensional accuracy.

Advantageous embodiments and developments may be taken from the further, dependent claims and from the description, with reference to the figures of the drawings.

In a preferred embodiment, the matrix material is introduced into the textile planar structure before method step (a) by injection. In addition or alternatively, it would also be conceivable for the matrix material to be introduced into this textile planar structure before step (a) by providing tapes which are impregnated at least in part with the matrix material and which are brought into contact with the textile planar structure. If tapes of this type are used, which are impregnated with matrix material, they may for example only be impregnated in portions, these portions defining the regions which are to comprise a matrix material when the tape is brought into contact with the textile planar structure. Advantageously, if tapes are used, the textile planar structure is pressed together with the tape applied thereto, and the matrix material can thus penetrate into the textile planar structure.

For method step (a), preferably merely the inner regions of the textile planar structure are impregnated with the matrix. This means that the edge regions of the textile planar structure are left free for connecting or stitching corresponding edge regions of another or the same component.

In a preferred embodiment, the entire textile planar structure is heated in method step (b). It would also be conceivable for merely the first sub-regions of the textile planar structure to be heated locally, but this is more complex than heating the entire textile planar structure, especially since the first sub-regions typically constitute the majority of the area of the textile planar structure as a whole. In addition or alternatively, it is advantageous if in method step (e), merely the second sub-regions of the textile planar structure are locally heated, i.e. the regions which are connected to another or to the same textile planar structure by stitching It would also be conceivable for the entire textile planar structure to be heated in method step (e), analogously to method step (b), but this is not very economical, since the second sub-regions typically only constitute a small fraction of the area of the textile planar structure as a whole.

In a preferred embodiment, before method step (b), the textile planar structure which is impregnated in portions is shaped as desired. This shape roughly corresponds, as a first approximation, to the final shape of the component to be manufactured. Subsequently, the shaped textile planar structure which has been impregnated in portions is heated for curing.

The textile planar structure is preferably shaped, and subsequently cured, in an autoclave. An autoclave denotes a pressurised container which can be sealed in a gas-tight manner and is used for high-pressure heat treatment of substances. Autoclaves are used inter alia for producing fibre/plastics material composites. In this case, pressures of up to 10 bar and temperatures of up to 400° C. are typically produced in the autoclaves. The high pressure in the interior of an autoclave is used to compact the individual layers of a textile planar structure. The matrix material in the fibre composite material, generally epoxy resin, is cured for several hours at a high temperature in the range of 100° C.-250° C.

In a preferred embodiment, in step (c) the second sub-region of the textile planar structure is stitched to corresponding second sub-regions of another textile planar structure, which is not impregnated with a matrix and is not cured. In this way, two large-area components, such as two fuselage half-shells, are connected by simply stitching the non-impregnated and thus non-cured edge regions thereof. As a result of the cured inner regions, which are formed by the impregnated and cured first sub-regions, the corresponding components or the corresponding textile planar structures have a very high inherent rigidity, and can be adjusted to and aligned with one another for this connection process in a very simple manner and with high dimensional accuracy.

In an alternative embodiment, in step (c), second sub-regions of a textile planar structure can be stitched to corresponding second sub-regions of the same textile planar structure. This provides a single-part, single-piece component, which after corresponding shaping is connected at the edges by stitching For example, it is thus advantageously possible to connect smaller fuselage components or other components from a single textile planar structure, impregnated with a matrix in an adapted manner, by adapted deformation and stitching.

In a preferred embodiment, the method according to the invention is used for producing fuselages, fuselage portions, aerofoils and/or horizontal tail planes of aircraft or spacecraft.

In a preferred embodiment, fibre interlaid scrims are provided as the textile planar structure. Preferably, carbon-fibre interlaid scrims or glass-fibre interlaid scrims are provided. Interlaid scrims refer to a specific textile planar structure which is used inter alia for reinforcement in fibre composite materials. Instead of interlaid scrims of this type, it is also conceivable to use a woven fabric as a textile planar structure. Unlike woven fabrics, however, interlaid scrims can be draped much more easily and have better mechanical properties in the composite, since the fibres are already stretched and the orientation of the fibres can be defined specifically for the respective application. Interlaid scrims typically consist of a plurality of layers of mutually parallel fibres. The individual layers differ in fibre orientation, and the alignment thereof is provided at an angle to the direction of production. The individual layers are initially not interconnected, but are interconnected in fibre composite materials by introducing a matrix material and subsequently curing. In particular because of the improved handling, the individual layers can be merged together in the production process.

In a preferred embodiment, a carbon fibre mat or a glass fibre mat, which may be in the form of interlaid scrims or a woven fabric, is provided as the textile planar structure.

In a typical embodiment, a polymer matrix is used as the matrix. A matrix comprising epoxy resin may also be used as the polymer matrix. In this case, the epoxy resin forms a substrate material which is adapted to absorb shearing forces. A precisely measured amount of a curing agent is mixed into the matrix, and is provided so as to cure the polymer matrix when heat is introduced. In addition or alternatively, it would also be conceivable to use a matrix comprising phenol resin. Besides these, the matrix may also comprise or contain other thermosetting polymers or thermoplastics. Besides the use of a polymer matrix, a ceramic material matrix such as is used in ceramic material fibre composites would also be conceivable.

In a preferred embodiment of the aircraft or spacecraft, the component is formed as an aircraft fuselage, horizontal tail plane and/or aerofoil.

Within reason, the above embodiments and developments can be freely combined with one another. Further possible embodiments, developments and implementations of the invention also include combinations not explicitly mentioned of features of the invention which are described above or in the following in relation to the embodiments. In particular, the person skilled in the art will also add individual aspects as improvements or additions to the respective basic form of the present invention.

### BRIEF DESCRIPTION OF THE DRAWINGS

The present invention is described in greater detail in the following by way of the embodiments shown in the schematic figures of the drawings, in which:

FIG. 1, in sub-figures FIG. 1(A)-(E), shows the course of a first, general sequence of the method according to the invention;

FIG. 2 is a detail of the interconnected components of FIG. 1 in the region of the seam;

FIG. 3, in sub-figures FIG. 3(A)-(H), shows the course of a second, preferred embodiment of the method according to the invention;

FIG. 4 is detail from FIG. 3(D) in the region of the seam; and

FIG. 5, in sub-figures FIG. 5(A)-(C), shows three methods for introducing the matrix material into the textile planar structure.

The appended drawings are intended to provide improved understanding of the embodiments of the invention. They illustrate embodiments and are intended, in combination with the description, to describe principles and concepts of the invention. Other embodiments and many of the stated advantages can be seen from the drawings. The elements of the drawings are not necessarily shown in proportion to one another.

In the figures of the drawings, like, functionally equivalent and identically acting elements, features and components are provided with like reference numerals in each case, unless otherwise specified.

### DETAILED DESCRIPTION OF THE PREFERRED EMBODIMENTS

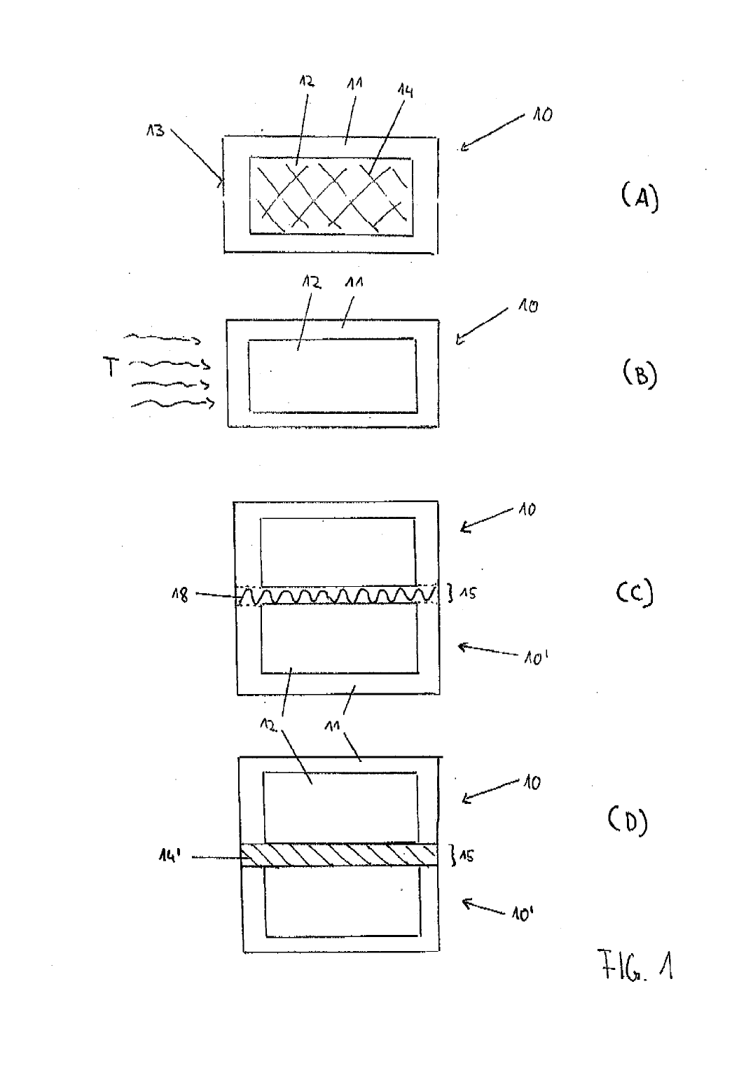

FIG. 1, in sub-FIGS. 1A to 1E, shows a first embodiment for producing and connecting fibre-reinforced components. In the following, it is to be assumed that these are components of an aircraft or spacecraft and in particular a fuselage component of an aircraft.

FIG. 1A shows a textile planar structure denoted by reference numeral 10. The textile planar structure 10 comprises a first, inner sub-region 12 and a second, outer sub-region 11 which completely encloses the first sub-region 12. The second sub-region 11 is arranged peripherally on an edge 13 of the textile planar structure 10, in such a way that the first sub-region 12 is separated from the edge 13 by the second sub-region 11. In the present example, it is to be assumed that the first sub-region 12 is impregnated over an area by a polymer matrix 14, which in the present embodiment is formed as an epoxy resin 14.

In a second method step, as shown in FIG. 1B, the textile planar structure 10 is heated, for example to a temperature T=400° C., and in this case the entire textile planar structure 10, i.e. the first and second sub-regions 12, 11, are subjected to the heat treatment. The temperature T used is selected in such a way that the polymer matrix 14 in the first sub-region 12 of the textile planar structure 10 can cure. For this purpose, the polymer matrix 14 comprises a curing agent, which can cure at the accordingly used temperature T.

In a subsequent method step, shown in FIG. 1C, two different textile planar structures 10, 10′ are initially brought into mutual overlap at the second sub-regions 11. In this lap region 14, the two textile planar structures 10 do not initially comprise any cured polymer matrix. The two textile planar structures 10, 10′ are in this case stitched together in the lap region 15, in such a way that the two textile planar structures 10, 10′ are interconnected by a seam 18.

In a subsequent method step, as shown in FIG. 1D, a further polymer matrix 14′ is introduced at least into the stitched second sub-regions 11 or into the entire lap region 15 of the two textile planar structures 10, 10′.

Finally, the two textile planar structures 10, 10′ are heated, as shown in FIG. 1E. They are preferably heated locally, merely in the lap region 15, and thus in the region where the further polymer matrix 14′ is introduced, in such a way that the polymer matrix introduced in the region of the seam 18 can cure. This results in a component 20 which comprises a cured polymer matrix 14′ in the lap region 15 of the two fibre-reinforced planar structures 10, 10′.

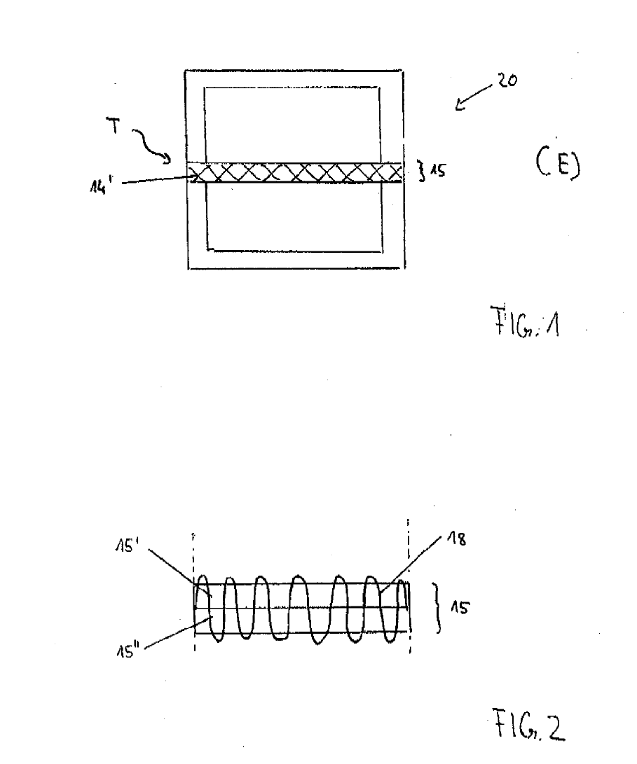

FIG. 2 shows the lap region 15 in detail. It can be seen that in the lap region 15, the second sub-regions 15′, 15″, which are not impregnated with a polymer matrix and cured, are stitched together anisotropically by means of a seam 18. The stitching may for example use composite fibres.

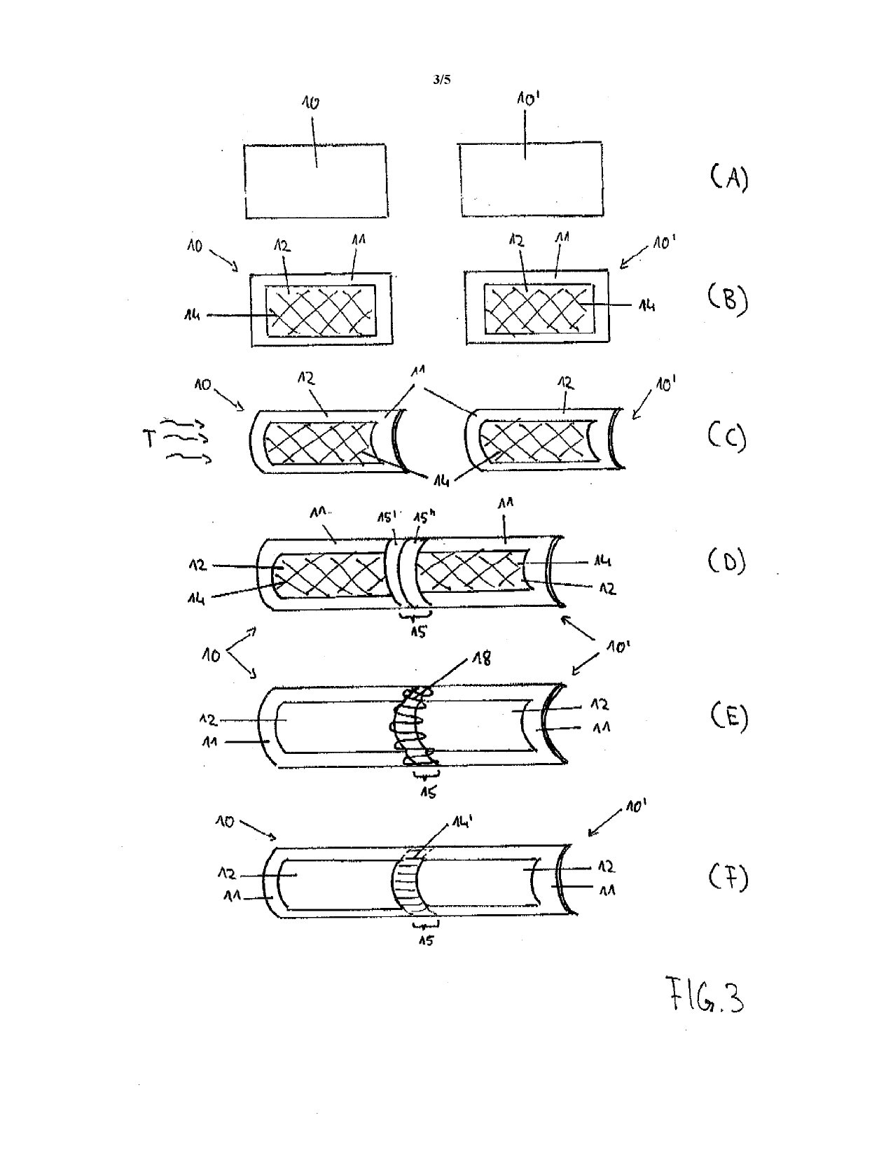

FIG. 3, in various sub-FIGS. 3A to 3H, shows a second embodiment for a particularly preferred method for connecting fibre-reinforced components.

In a first method step, as shown in FIG. 3A, two textile planar structures 10, 10′ are provided.

As shown in FIG. 3B, a polymer matrix 14 is introduced into the two textile planar structures 10, 10′.

Subsequently, as shown in FIG. 3C, the textile planar structures 10, 10′ impregnated in this manner with a polymer matrix 14 are shaped and heated in an autoclave, which for reasons of clarity is not shown here. In this case, the polymer matrix 14 in the first sub-region is cured.

Subsequently, as shown in FIG. 3D, the textile planar structures 10, 10′ heated and cured in this manner are positioned with respect to and aligned with one another, in that the respective, opposing second sub-regions 15′, 15″ of the two textile planar structures 10, 10′ are arranged on top of one another in a lap region 15. The respective second sub-regions 15′, 15″ are laid at 90°, as in a flange.

Subsequently, as shown in FIG. 3E, the second sub-regions, laid on top of one another in this manner, of the two textile planar structures 10, 10′ are stitched together anisotropically, resulting in a seam 18.

Subsequently, as shown in FIG. 3F, a further polymer matrix 14′ is introduced at least in portions into the lap region 15 and thus into the region of the seam 18. The polymer matrix 14′ may for example be introduced by local injection of an epoxy resin or another matrix material.

Finally, as shown in FIG. 3G, the lap region 15 is locally heated. This may for example be provided by a heating sleeve laid around the lap region. Alternatively, the heat may also be introduced by a heat and pressure sleeve arranged locally around the lap region 15. Placing two half-shell components 10, 10′ of this type in sequence and interconnecting them, as shown in FIG. 3G, produces a complete half-shell component 20. This component 20 forms for example an assembled half-shell 20 for an aircraft fuselage.

Connecting a half-shell construction 20 of this type to another half-shell component 20 at seam points 22, using the method steps shown in FIG. 3A to 3G in an analogous manner, results in a complete fuselage component 21, as shown in FIG. 3H.

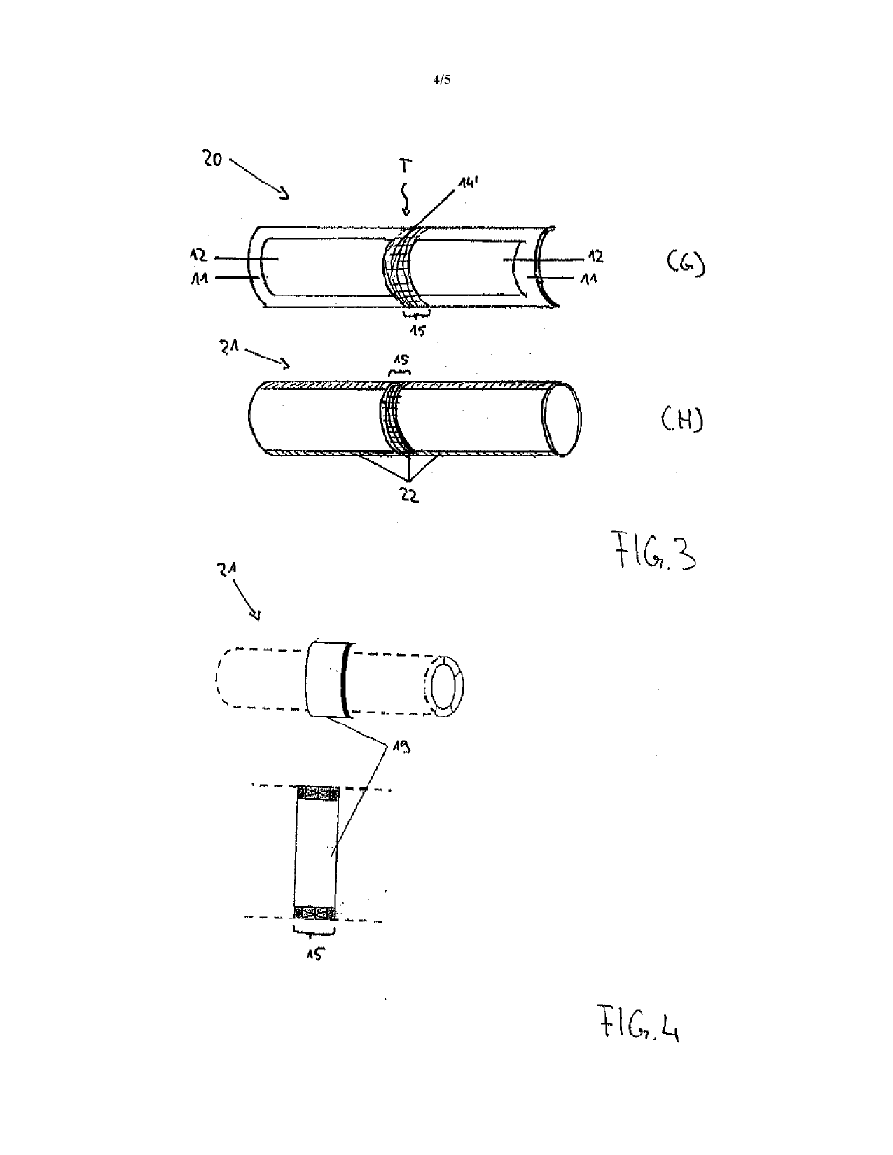

FIG. 4 is a sectional drawing at the chord from the inside, showing a detail of the produced component 21 in the lap region 15 to which the heat and pressure sleeve 19 is applied. Via this heat and pressure sleeve 19, which thus to some extent forms a local autoclave, heat can advantageously be introduced locally, merely into the lap region 15.

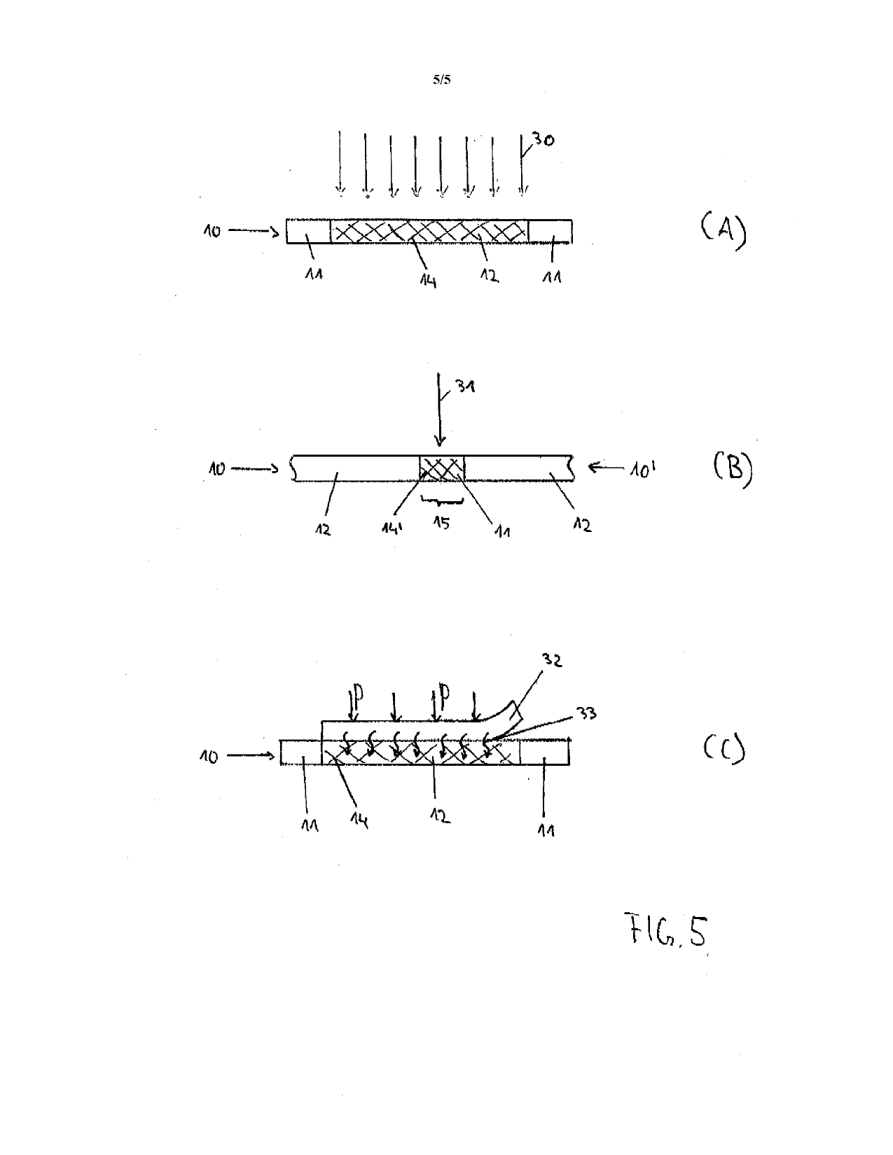

FIG. 5, in sub-FIGS. 5A to 5C, shows various options for introducing a polymer matrix into a textile planar structure.

The polymer matrix 14 can, as shown in FIG. 5A, be introduced over an area by surface spraying 30 an epoxy resin into the textile planar structure 10. In this way, for example, the planar first sub-regions 12 impregnated with a polymer matrix 14, as shown in FIG. 1A and 3B, can be produced.

Moreover, the epoxy resin may also be introduced locally into corresponding portions of the textile planar structure 10, as shown in FIG. 5B. In this way, edge regions, point regions or strip regions of a textile planar structure can be selectively impregnated with the polymer resin. The introduction 31 is provided by injection using a nozzle which can be positioned precisely. In this way for example, a polymer matrix 14′ can be introduced into the lap region 15, as is shown in FIG. 1D and 3F.

In addition or alternatively, it would also be conceivable for the polymer matrix 14 to be applied by applying a surface tape 32 or tape 32 in strips or spots to the corresponding regions of the textile planar structure 10 which are to be impregnated with the polymer matrix 14, instead of by injection. These tapes 32 may for example be impregnated in regions, the impregnated regions being selected so as to define the sub-regions of the textile planar structure 10 which are to be impregnated with the polymer matrix 14. Applying these tapes 32 and for example applying a pressure P makes it possible for the polymer matrix 14 to seep into the textile planar structure 10, as shown by the arrows 33. A method of this type is shown in FIG. 5C.

Although the present invention has been disclosed in the above entirely by way of preferred embodiments, it is not limited thereto, but can be modified in various ways.

The invention is preferably provided for producing fuselages, fuselage portions, aerofoils and/or horizontal tail planes of an aircraft or spacecraft. However, the invention is not limited thereto, but can also advantageously be used in any other desired applications, for example in ship and yacht construction, in vehicle construction, in sports devices, in automobile technology, for adhesive tapes and the like.

The invention is also not intended to be limited to the numbers and materials specified above, which are to be understood merely as exemplary.

Within reason, the sequence of the stated method steps can also potentially be varied or be supplemented with further method steps.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-14. (canceled)

15. A method for producing and connecting fibre-reinforced components, comprising the steps of:
(a) providing a textile planar structure, of which merely a first sub-region is impregnated with a matrix;
(b) heating the textile planar structure which is impregnated in part, in such a way that the matrix provided in the first sub-region of the textile planar structure cures;
(c) connecting the textile planar structure in a second sub-region of the textile planar structure, different from the first sub-region, by stitching the second sub-regions;
(d) introducing a further matrix at least into the stitched second sub-regions of the textile planar structure; and
(e) heating the impregnated textile planar structure in such a way that the further matrix present in the stitched second sub-regions of the textile planar structure cures.

16. The method according to claim 15, wherein, before the step of providing a textile planar structure, the matrix is introduced into the textile planar structure by injecting a matrix material into the textile planar structure and/or by providing tapes, impregnated in part with a matrix material, which are brought into contact with the textile planar structure.

17. The method according to claim 15, wherein, for the step of providing a textile planar structure, only the inner regions of the textile planar structure are impregnated with the matrix.

18. The method according to claim 15, wherein, before the step of heating the textile planar structure which is impregnated in part, the textile planar structure which is impregnated in portions is shaped as desired, and subsequently the shaped textile planar structure which is impregnated in portions is heated.

19. The method according to claim 18, wherein the textile planar structure is shaped and subsequently cured in an autoclave.

20. The method according to claim 15, wherein, in the step of heating the textile planar structure which is impregnated in part, at least one of the entire textile planar structure is heated and only the region of at least the second sub-regions is heated.

21. The method according to claim 15, wherein, in the step of connecting the textile planar structure in a second sub-region of the textile planar structure, the second sub-region of the textile planar structure is stitched to corresponding second sub-regions of another textile planar structure, which is not impregnated with a matrix and is not cured.

22. The method according to claim 15, wherein, in the step of connecting the textile planar structure in a second sub-region of the textile planar structure, the second sub-region is stitched to corresponding second sub-regions of the same textile planar structure.

23. The method according to claim 15, wherein the method is provided for producing at least one of fuselages, fuselage portions, aerofoils and horizontal tail planes of an aircraft or spacecraft.

24. The method according to claim 15, wherein fibre interlaid scrims are provided as the textile planar structure.

25. The method according to claim 24, wherein the fibre interlaid scrims comprise one of carbon-fibre interlaid scrims and glass-fibre interlaid scrims.

26. The method according to claim 15, wherein one of a carbon-fibre mat and a glass-fibre mat is provided as the textile planar structure.

27. The method according to claim 15, wherein a polymer matrix, is provided as the matrix.

28. The method according to claim 27, wherein the polymer matrix comprises one of an epoxy resin and a phenol resin.

29. An aircraft or spacecraft comprising a plurality of fibre-reinforced components, wherein at least two of the components are interconnected by a method according to claim 15.

30. The aircraft or spacecraft according to claim 29, wherein the component is formed as one of an aircraft fuselage, a horizontal tail plane and an aerofoil.
